(19) United States
(12) Patent Application Publication
(10) Pub. No.: US 2022/0355762 A1
(43) Pub. Date: Nov. 10, 2022

(54) APPARATUS AND METHOD FOR CONTROLLING VEHICLE DOOR

(71) Applicants: Hyundai Motor Company, Seoul (KR); Kia Corporation, Seoul (KR)

(72) Inventors: Hee Gun YANG, Whasung-Si (KR); Jong Joo KIM, Whasung-Si (KR)

(21) Appl. No.: 17/505,373

(22) Filed: Oct. 19, 2021

(30) Foreign Application Priority Data
May 10, 2021 (KR) 10-2021-0060246

(51) Int. Cl. B60R 25/24; B60R 16/033; B60R 25/32; B60R 21/013; B60R 25/40; G07C 5/08; B60R 16/023

(52) U.S. Cl. CPC B60R 25/24; B60R 16/033; B60R 25/32; B60R 21/013; B60R 25/403; G07C 5/0808; B60R 16/0238

(57) ABSTRACT

An apparatus and a method for controlling a vehicle door are provided to automatically unlock a door locked in vehicle crash. The apparatus includes a main battery, a sub-battery, a door actuator to lock or unlock the vehicle door, and a door controller to unlock the vehicle door which is locked by supplying electric power to the door actuator through the sub-battery, when the door controller determines that supply of electric power from the main battery is failed in the vehicle crash.

### CROSS-REFERENCE TO RELATED APPLICATION

The present application claims priority to Korean Patent Application No. 10-2021-0060246, filed in the Korean Intellectual Property Office on May 10, 2021, the entire contents of which is incorporated herein for all purposes by this reference.

### BACKGROUND OF THE INVENTION

### Field of the Invention

The present invention relates to an apparatus and a method for controlling a vehicle door, capable of automatically unlocking a vehicle door locked, in a car accident.

### Description of Related art

When an accident occurs in a vehicle traveling, a significant impact may be exerted on lifesaving depending on whether a door is unlocked. Accordingly, a vehicle is equipped with a crash unlock system to unlock a door, which is locked, in vehicle crash. The crash unlock system fails to unlock the door, which is locked, because an airbag control unit (ACU) fails to transmit a signal resulting from vehicle crash, as a 12V battery or a junction box mounted in an engine room is broken or wiring is damaged in the vehicle crash. In addition, even if the ACU transmits the signal, which results from the vehicle crash, to a micro control unit (MCU), battery power may be cut off before a door unlock relay or a door actuator is operated, so the locked vehicle door is not unlocked.

The information disclosed in this Background of the Invention section is only for enhancement of understanding of the general background of the invention and may not be taken as an acknowledgement or any form of suggestion that this information forms the prior art already known to a person skilled in the art.

### SUMMARY

Various aspects of the present invention are directed to providing an apparatus and a method for controlling a vehicle door, capable of unlocking a door, which is locked, by using a sub-battery in the situation that supply of power is failed, as a main battery is damaged in vehicle accident.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for controlling a vehicle door includes a main battery, a sub-battery, a door actuator to lock or unlock the vehicle door, and a door controller to unlock the vehicle door which is locked by supplying electric power to the door actuator through the sub-battery, when the door controller concludes that supply of electric power from the main battery is failed in a predetermined condition.

The sub-battery is mounted inside the vehicle.

The sub-battery includes a switch to distribute the electric power output from the sub-battery.

The switch includes an intelligent power switch (IPS) or a relay.

The door controller controls the switch to supply the electric power output from the sub-battery to the door actuator.

The apparatus for controlling a vehicle door further includes an airbag control unit to sense the vehicle crash by using a sensor mounted in a vehicle.

The door controller transmits, to the door actuator, a signal for instructing the door actuator to unlock the locked door, when the door controller receives a vehicle crash signal from the airbag control unit.

The door controller determines whether the main battery and a junction box connected with an output terminal of the main battery are damaged when receiving the vehicle crash signal, and determines supply of electric power from the main battery as being failed when the door controller concludes that damage to at least one of the main battery or the junction box is sensed.

The door actuator unlocks the locked vehicle door by operating a door latch using power supplied from the sub-battery.

According to another aspect of the present disclosure, a method for controlling a vehicle door includes sensing vehicle crash, determining whether supply of electric power from a main battery is possible when sensing the vehicle crash, and unlocking a locked vehicle door by supplying electric power to a door actuator through a sub-battery, when the supply of the electric power from the main battery is failed.

The sensing of the vehicle crash includes sensing, by an airbag control unit, the vehicle crash by using a sensor mounted in a vehicle, and receiving a vehicle crash signal from the airbag control unit.

The determining of whether the supply of the electric power from the main battery is possible includes determining whether the main battery and a junction box connected with an outer terminal of the main battery is damaged, and determining the supply of the electric power from the main battery as being failed when the door controller concludes that damage to at least one of the main battery or the junction box is sensed.

The unlocking of the locked vehicle door includes transmitting a signal for instructing unlocking the locked vehicle door to the door actuator, supplying the electric power output from the sub-battery to the door actuator, and unlocking, by the door actuator, the locked vehicle door by operating a door latch using power supplied from the sub-battery.

The method for controlling the vehicle door includes supplying the electric power output from the main battery to the door actuator, when the supply of the electric power from the main battery is possible, and unlocking, by the door actuator, the locked vehicle door by operating a door latch using the power supplied from the main battery.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating an apparatus for controlling a vehicle door, according to embodiments of the present disclosure;

FIG. 2 is a flowchart illustrating a method for controlling a vehicle door, according to embodiments of the present disclosure; and

FIG. 3 is a block diagram illustrating a computing system to execute the method for controlling the vehicle door, according to embodiments of the present disclosure.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, some embodiments of the present disclosure will be described in detail with reference to accompanying drawings. In adding the reference numerals to the components of each drawing, it should be noted that the identical or equivalent component is designated by the identical numeral even when they are displayed on other drawings. In addition, in the following description of an embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, “(a)”, “(b)”, and the like may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

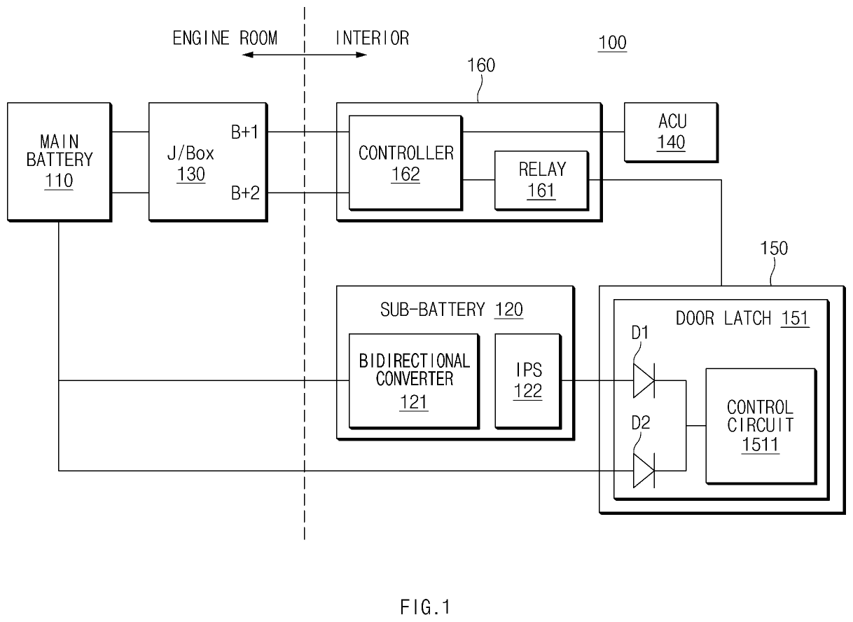

FIG. 1 is a block diagram illustrating an apparatus for controlling a vehicle door, according to embodiments of the present disclosure.

An apparatus 100 for controlling a vehicle door may release the locking of a door locking device (latch) in vehicle crash (e.g., collision and/or fire) through a crash unlock function. Referring to FIG. 1, the apparatus 100 for controlling a vehicle door may include a main battery 110, a sub-battery 120, a junction box (J/Box) 130, an airbag control unit (ACU) 140, a door actuator 150, and a door controller 160.

The main battery 110, which is mounted in an engine room of the vehicle, may supply main power. The main battery 110 may supply power (e.g., power of 12V) to electronic parts, such as the ACU 140, the door actuator 150, and/or the door controller 160, in the vehicle.

The sub-battery 120 may be mounted in a vehicle interior, for example, under a seat or in a trunk. The sub-battery 120 may supply sub-power to the electronic part, when the supply of the main power is failed. The sub-battery 120 may be a battery of a built-in cam or a sub-battery used as redundant power.

The sub-battery 120 may include a bidirectional converter 121 and an intelligent power switch (IPS) 122. The bidirectional converter 121 may convert the electric power output from the main battery 110 and supply the converted power to the sub-battery 120. The bidirectional converter 121 may convert the electric power output from the sub-battery 120 and supply the converted power to the main battery 110 and/or the door controller 160. The IPS 122 may distribute power (sub-power) output from the sub-battery 120 to the ACU 140, the door actuator 150, and/or the door controller 160. Although FIG. 1 illustrates that the sub-battery 120 includes the IPS 122, the present disclosure is not limited thereto. For example, the IPS 122 may be implemented by being replaced with a relay.

The junction box 130 may be connected with an output terminal of the main battery 110. The junction box 130 may distribute the main the electric power output from the main battery 110 to electric loads, that is, the ACU 140, the door actuator 150, and/or the door controller 160. The junction box 130 may include a fuse and/or a relay and may be installed in the engine room.

The ACU 140 may control airbag deployment in vehicle crash. The ACU 140 may sense vehicle crash by using an acceleration sensor mounted inside the ACU 140. The ACU 140 may determine whether to deploy the airbag, based on a sensor value obtained through measurement of the acceleration sensor. The ACU 140 may determine the airbag to be deployed when the measured sensor value exceeds a threshold value, and may determine the airbag not to be deployed, when the measured sensor value is less than or equal to the threshold value. The ACU 140 may generate a signal (that is, a vehicle crash signal) indicating the vehicle crash, when sensing the vehicle crash. The ACU 140 may transmit the vehicle crash signal to the door controller 160.

The door actuator 150 may perform a door locking operation or a door unlocking operation. The door actuator 150 may include a door latch 151 which serves as the door locking device. The door latch 151 may include diodes “D1” and “D2” and a control circuit 1511. The door latch 151 may receive electric power from the main battery 110 or the sub-battery 120 to operate. The control circuit 1511 may control the operation of the door latch 151 to lock or unlock the door.

The door controller 160 may control locking and unlocking of the vehicle door. The door controller 160 may include a relay 161 and a controller 162. The relay 161 may transmit a control signal output from the controller 162 to the door actuator 150. The relay 161 may transmit a signal (that is, a door unlocking signal) for instructing unlocking a door, to the door actuator 150, in response an instruction from the controller 162. The controller 162, which controls the overall operation of the door controller 160, may include at least one processor and a memory. The processor may be implemented with at least one of application specific integrated circuits (ASIC), digital signal processors (DSP), programmable logic devices (PLD), field programmable gate arrays (FPGA), central processing units (CPU), micro-controllers (MCU) and/or microprocessors. The memory (not illustrated) may be a non-transitory storage medium that stores instructions executed by the processor. The memory (not illustrated) may be implemented with at least one of storage media of a flash memory, a hard disk, a secure digital card, a random access memory (RAM), a static random access memory (SRAM), a read only memory (ROM), a programmable read only memory (PROM), an electrically erasable and programmable (EEPROM), an erasable and programmable ROM (EPROM), and/or a register. The memory may be positioned inside or outside the controller 162.

The controller 162 may receive the vehicle crash signal from the ACU 140. Although the present embodiment has been described in that the controller 162 receives the vehicle crash signal from the ACU 140, the present disclosure is not limited thereto. For example, the present embodiment may be implemented such that the controller 162 senses the vehicle crash by using a separate impact sensor and/or a separate fire sensor.

The controller 162 may determine whether the supply of the main power is possible, when vehicle crash occurs. The controller 162 may sense that the supply of the main power is failed, by using a sensor (e.g., a voltage sensor or a current sensor), when the supply of the main power is failed, as the main battery 110 and/or the junction box 130 is damaged.

The controller 162 may unlock the door, which is locked, by using the main power (power) output from the main battery 110 when the main power supply is possible. The controller 162 may supply the power, which is output from the main battery 110, to the door actuator 150, when the supply of the main power is possible. In addition, the controller 162 may transmit the door unlocking signal to the control circuit 1511 of the door actuator 150 through the relay 161.

When the supply of the main power is failed, the controller 162 may unlock the door, which is locked, by using the sub-the electric power output from the sub-battery 120. The controller 162 may control the IPS 122 of the sub-battery 120 such that the sub-battery 120 supplies power to the door latch 151 of the door actuator 150, when the supply of the main power is failed. In addition, the controller 162 may transmit the door unlocking signal to the door actuator 150. The control circuit 1511 of the door latch 151 inside the door actuator 150 may operate the door latch 151 in response to the instruction of the controller 162 to unlock the door locked.

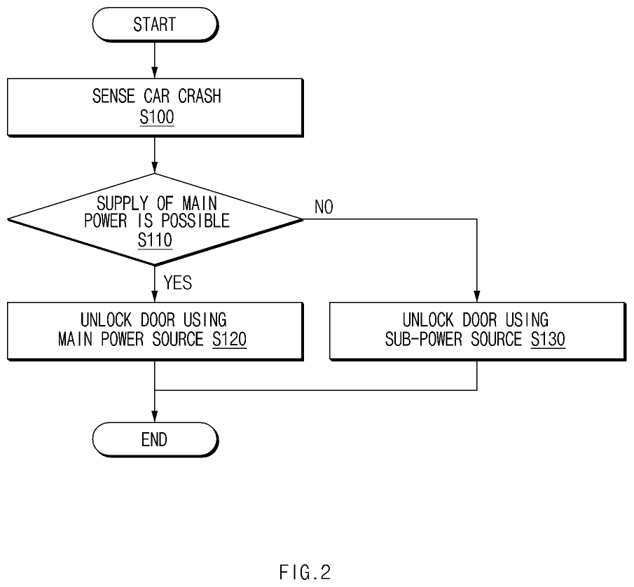

FIG. 2 is a flowchart illustrating a method for controlling a vehicle door, according to embodiments of the present disclosure.

Referring to FIG. 2, the door controller 160 may sense vehicle crash (S100). The ACU 140 may sense the vehicle crash by using a sensor. The ACU 140 may transmit a signal (that is, the vehicle crash signal) resulting from the vehicle crash, to the door controller 160. The door controller 160 may receive the vehicle crash signal from the ACU 140 through data communication.

The door controller 160 may determine whether the supply of the main power is possible, when sensing the vehicle crash (S110). The door controller 160 may determine whether to receive the main the electric power output from the main battery 110. The door controller 160 may sense damage to the main battery 110 and/or the junction box 130 by using the current sensor and/or the voltage sensor. The door controller 160 may determine the supply of the main power as being failed, when sensing the damage to the main battery 110 and/or the junction box 130. In other words, the door controller 160 may determine that the supply of the power is failed by using the main battery 110.

The door controller 160 may unlock the door locked, by using the main power, when the supply of the main power is possible (S120). The door controller 160 may transmit the door unlocking signal to the door actuator 150. In this case, simultaneously, the door controller 160 may transmit a signal (that is, a main power supply enable signal) representing that the supply of the main power is possible. The control circuit 1511 of the door actuator 140 may unlock the door locked by receiving the electric power output from the main battery 110, that is, the main power to operate the door latch 151.

The door controller 160 may unlock the door locked by using sub-power when the supply of the main power is failed. In addition, the door controller 160 may transmit the door unlocking signal to the door actuator 150. The door controller 160 may transmit a signal (main power supply disable signal) indicating that the supply of the main power is failed, in addition to the door unlocking signal. The door controller 160 may control the IPS 122 of the sub-battery 120 to supply the electric power output from the sub-battery 120 to the door latch 151 of the door actuator 150. The door actuator 150 may unlock the door locked by operating the door latch 151 using the sub-power supplied from the sub-battery 120.

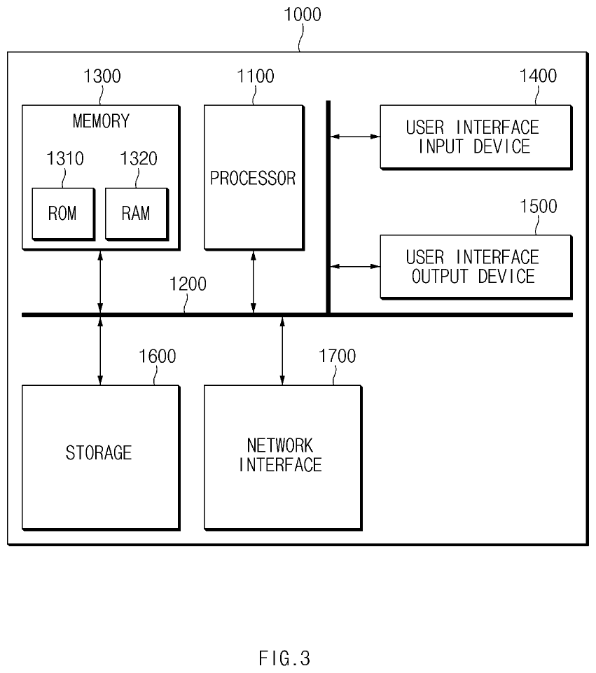

FIG. 3 is a block diagram illustrating a computing system to execute the method for controlling the vehicle door, according to embodiments of the present disclosure.

Referring to FIG. 3, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM; see 1310) and a random access memory (RAM; see 1320).

Thus, the operations of the methods or algorithms described in connection with the embodiments disclosed in the present disclosure may be directly implemented with a hardware module, a software module, or the combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The exemplary storage medium may be coupled to the processor 1100. The processor 1100 may read out information from the storage medium and may write information in the storage medium. Alternatively, the storage medium may be integrated with the processor 1100. The processor 1100 and storage medium may reside in an application specific integrated circuit (ASIC). The ASIC may reside in a user terminal. Alternatively, the processor 1100 and the storage medium may reside as separate components of the terminal of the user.

According to the present disclosure, the door, which is locked, may be unlocked by using the sub-battery in the situation that the supply of power is failed, as the main battery is damaged in vehicle accident. Accordingly, the occupant may be easily escaped from the vehicle and the lifesaving may be easily performed, thereby contributing to improving vehicle safety and productivity.

In addition, according to the present disclosure, even if the customer meets with an accident while driving the vehicle, the door of the vehicle may be easily opened such that the customer is easily escaped from the vehicle.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for controlling a vehicle door of a vehicle, the apparatus comprising:
a main battery;
a sub-battery;
a door actuator electrically connected to the main battery and configured to lock or unlock the vehicle door; and
a door controller electrically connected to the door actuator and configured to unlock the vehicle door which is locked, by supplying electric power to the door actuator through the sub-battery, when the door controller concludes that supply of electric power from the main battery is failed in a predetermined condition.

2. The apparatus of claim 1, wherein the predetermined condition is a state of the vehicle in vehicle crash.

3. The apparatus of claim 1, wherein the sub-battery is mounted inside the vehicle.

4. The apparatus of claim 1, wherein the sub-battery includes a switch to distribute the electric power output from the sub-battery.

5. The apparatus of claim 4, wherein the switch includes an intelligent power switch (IPS) or a relay.

6. The apparatus of claim 4, wherein the door controller electrically connected to the switch is configured to control the switch to supply the electric power output from the sub-battery to the door actuator, when the door controller concludes that supply of the electric power from the main battery is failed in the predetermined condition.

7. The apparatus of claim 2, further comprising:
an airbag control unit configured to sense the vehicle crash by using a sensor mounted in the vehicle.

8. The apparatus of claim 7, wherein the door controller electrically connected to the airbag control unit is configured to transmit, to the door actuator, a signal for instructing the door actuator to unlock the locked door, when the door controller receives a vehicle crash signal from the airbag control unit.

9. The apparatus of claim 8, wherein the door controller is configured to:
determine whether the main battery and a junction box connected with an output terminal of the main battery are damaged, when the door controller receives the vehicle crash signal; and
determine the supply of the electric power from the main battery to the door actuator as being failed, when the door controller concludes that damage to at least one of the main battery or the junction box is sensed.

10. The apparatus of claim 1, wherein the door actuator unlocks the locked vehicle door by operating a door latch using power supplied from the sub-battery.

11. A method for controlling a vehicle door of a vehicle, the method comprising:
sensing a condition of the vehicle;
determining, by a door controller, whether supply of electric power from a main battery to a door actuator of the vehicle door is possible, when the door controller concludes that the sensed condition of the vehicle is in a vehicle crash; and
unlocking, by the door controller electrically connected to the door actuator, the vehicle door which is locked, by supplying electric power to the door actuator through a sub-battery, when the door controller concludes that the supply of the electric power from the main battery is failed.

12. The method of claim 11, wherein the sensing of the condition of the vehicle includes:
sensing, by an airbag control unit electrically connected to the door controller, the vehicle crash through a sensor mounted in the vehicle; and
receiving, by the door controller, a vehicle crash signal from the airbag control unit.

13. The method of claim 11, wherein the determining of whether the supply of the electric power from the main battery is possible includes:
determining, by the door controller, whether the main battery and a junction box connected with an outer terminal of the main battery is damaged; and
determining, by the door controller, the supply of the electric power from the main battery as being failed, when the door controller concludes that damage to at least one of the main battery or the junction box is sensed.

14. The method of claim 11, wherein the unlocking of the locked vehicle door includes:
transmitting, by the door controller, a signal for instructing the door actuator to unlock the locked vehicle door to the door actuator;
supplying, by the door controller, the electric power output from the sub-battery to the door actuator; and
unlocking, by the door controller, the locked vehicle door by operating the door actuator to activate a door latch, using power supplied from the sub-battery.

15. The method of claim 11, further comprising:
supplying the electric power output from the main battery to the door actuator, when the door controller concludes that the supply of the electric power from the main battery is possible; and
unlocking, by the door actuator, the locked vehicle door by operating a door latch using the power supplied from the main battery.
